(19) United States
(12) Patent Application Publication
(10) Pub. No.: US 2025/0100325 A1
(43) Pub. Date: Mar. 27, 2025

(54) VEHICLE WHEEL SUPPORT APPARATUS

(71) Applicant: TOYOTA JIDOSHA KABUSHIKI KAISHA, Toyota-shi (JP)

(72) Inventors: Hironori FUJITA, Toyota-shi (JP); Hirotaka IKEGAMI, Toyota-shi (JP)

(73) Assignee: TOYOTA JIDOSHA KABUSHIKI KAISHA, Toyota-shi (JP)

(21) Appl. No.: 18/774,488

(22) Filed: Jul. 16, 2024

(30) Foreign Application Priority Data
Sep. 22, 2023 (JP) 2023-158461

(51) Int. Cl. B60B 27/00; B60B 27/02; G01P 3/487

(52) U.S. Cl. CPC B60B 27/0068; B60B 27/0015; B60B 27/02; G01P 3/487; B60B 2900/211

(57) ABSTRACT

A vehicle wheel support device includes: a hub bearing that rotatably supports a wheel; a hub carrier that supports the hub bearing; a sensor that detects a rotation state of the wheel; and an assembly member that is assembled to the hub bearing, the hub carrier, or both the hub bearing and the hub carrier, wherein the assembly member has a large-diameter protruding portion that cooperates with the hub carrier to prevent entry of foreign matter toward the sensor.

### REFERENCE TO RELATED APPLICATION

This application claims priority from Japanese Patent Application No. 2023-158461 filed on Sep. 22, 2023. The entire content of the priority application is incorporated herein by reference.

### TECHNICAL FIELD

The following disclosure relates to a vehicle wheel support device.

### BACKGROUND ART

For instance, an arrangement of a knuckle (as one form of a hub carrier), a hub bearing, a drive shaft, and a deflector disclosed in Japanese Patent Application Publication No. 2015-071339 is conventionally known. The conventional arrangement is an arrangement in a driving wheel in which the drive shaft is connected to a rotary body of the hub bearing supported by a hub carrier. In this arrangement, the deflector is fixed to the drive shaft.

### SUMMARY

On a driving wheel side, a sensor for detecting a rotation state of a wheel may be fixed to the hub carrier. The hub carrier is disposed in an environment in which foreign matter such as water, sand, or mud is likely to enter an inside of the hub carrier in accordance with traveling of the vehicle especially from an inner side of the vehicle in the left-right direction of the vehicle, i.e., a side opposite to an outer side of the vehicle on which the wheel is connected to the rotary body. Thus, the sensor fixed to the hub carrier is disposed in an environment in which the foreign matter is likely to adhere.

The sensor is required to maintain good detection accuracy even in the environment in which the foreign matter is likely to adhere. Thus, the deflector provided for the driving wheel is fixed to the drive shaft that is disposed inner than the hub carrier in the left-right direction of the vehicle, for preventing the foreign matter from adhering to the sensor that is disposed so as to face the hub bearing.

Thus, the configuration in which the deflector is provided favorably prevents the foreign matter from adhering to the sensor. However, the necessity of separately providing the deflector leads to an increase in the number of components.

Accordingly, an aspect of the present disclosure is to provide a vehicle wheel support device that ensures a reduction in the number of components.

In one aspect of the present disclosure, a vehicle wheel support device includes: a hub bearing that rotatably supports a wheel; a hub carrier that supports the hub bearing; a sensor that detects a rotation state of the wheel; and an assembly member that is assembled to the hub bearing, the hub carrier, or both the hub bearing and the hub carrier, wherein the assembly member has a large-diameter protruding portion that cooperates with the hub carrier to prevent entry of foreign matter toward the sensor.

According to the vehicle wheel support device of the present disclosure, the hub carrier and the large-diameter protruding portion of the assembly member cooperate with each other to prevent the foreign matter from adhering to the sensor. Thus, it is not necessary to separately prepare and assemble the deflector in the driving wheel of the vehicle, so that the number of components can be reduced. The reduction in the number of components, namely, the omission of the deflector, eliminates the need for performing an assembly work, thus resulting in a cost reduction.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which:

FIG. 1 is a schematic view of a vehicle wheel support device in a driving wheel;

FIG. 2 is a schematic view of a vehicle wheel support device in a driven wheel;

FIG. 3 is a view for explaining a configuration of a hub carrier

FIG. 4 is a view for explaining a configuration of a drive shaft;

FIG. 5 is a view for explaining a configuration of a cap;

FIG. 6 is a view for explaining a state in which entry of foreign matter is prevented by a small-diameter protruding portion and a large-diameter protruding portion on a driving wheel side;

FIG. 7 is a view for explaining a state in which entry of foreign matter is prevented by a small-diameter protruding portion and the cap on a driven wheel side;

FIG. 8 is a view for explaining configurations of a hub carrier and a drive shaft according to a first modification;

FIG. 9 is a view for explaining configurations of a hub carrier and a drive shaft according to a second modification;

FIG. 10 is a view for explaining a configuration of a deflector according to a third modification;

FIG. 11 is a view for explaining a cap according to a third modification; and

FIG. 12 is a view for explaining a deflector and a cap according to a fourth modification.

### DESCRIPTION

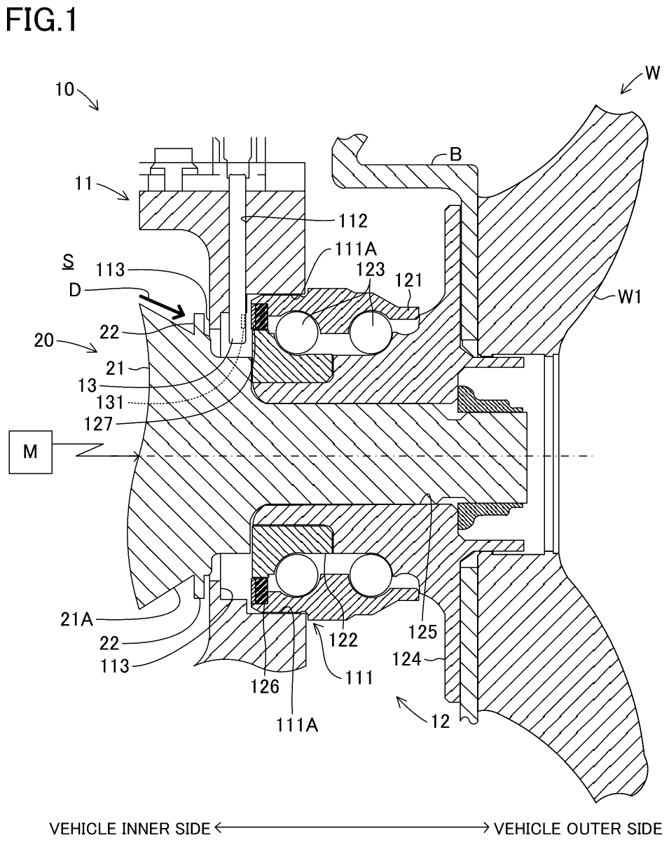

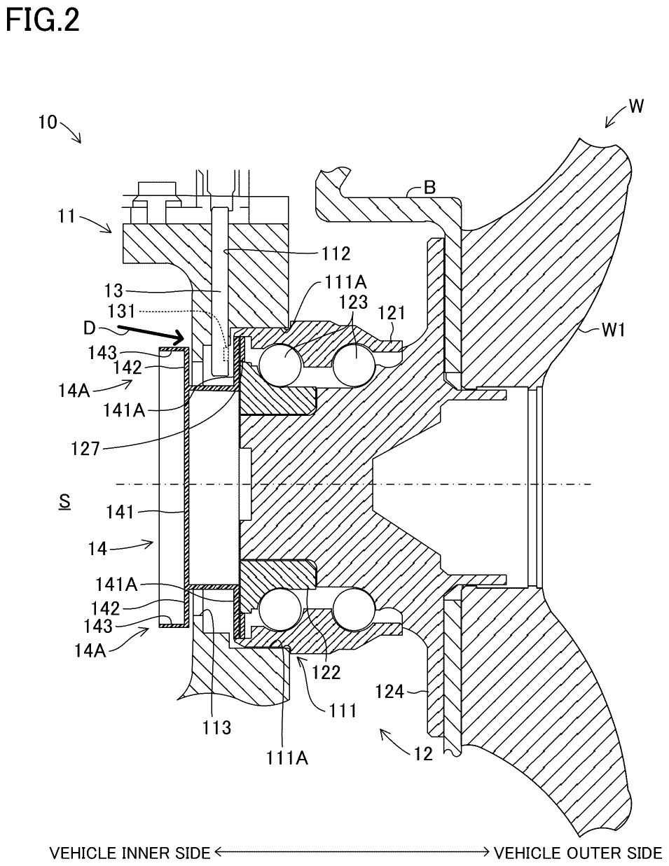

Referring to the drawings, there will be hereinafter described in detail a vehicle wheel support device according to an embodiment of the present disclosure. As illustrated in FIGS. 1 and 2, a vehicle wheel support device 10 of the present embodiment includes a hub carrier 11, a hub bearing 12, and a sensor 13.

As illustrated in FIG. 1, in a case where the vehicle wheel support device 10 supports a wheel driven by a drive source M such as a motor or an internal combustion engine mounted on the vehicle, namely, in a case where the vehicle wheel support device 10 supports a driving wheel, a drive shaft 20 as an assembly member is coupled to the vehicle wheel support device 10. As illustrated in FIG. 2, in a case where the vehicle wheel support device 10 supports a wheel which is not driven by the drive source M, namely, to which the drive shaft 20 is not coupled, and which follows the driving wheel, namely, in a case where the vehicle wheel support device 10 supports a driven wheel, the vehicle wheel support device 10 is provided with a cap 14 as an assembly member.

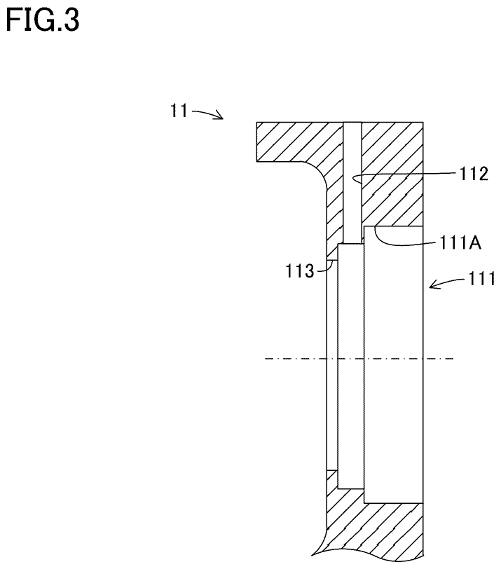

As illustrated in FIG. 3, the hub carrier 11 includes an accommodation hole portion 111 in which part of the hub bearing 12 is accommodated. The hub carrier 11 supports the hub bearing 12 in a state in which the hub carrier 11 is accommodated in the accommodation hole portion 111. Here, the hub carrier 11 may be referred to as a “knuckle” when the hub carrier 11 is provided for a steerable wheel of a vehicle. In the following description, the hub carrier 11 is referred to as a “hub carrier 11” regardless of whether the hub carrier 11 is provided for the steerable wheel or the non-steerable wheel.

The hub carrier 11 includes a fixing portion 112 in which a rod-shaped sensor 13 (that will be described later) is fitted such that the sensor 13 is fixed in a state in which a distal end portion of the sensor 13 protrudes from an inner circumferential surface 111A of the accommodation hole portion 111. The sensor 13 will be also referred to as a “stick sensor 13”. In this configuration, when the stick sensor 13 is fixed to the fixing portion 112, a detection portion 131 provided at the distal end portion of the stick sensor 13 protrudes from the inner circumferential surface 111A of the accommodation hole portion 111.

As illustrated in FIGS. 1, 2, and 3, the hub carrier 11 has a small-diameter protruding portion 113. The small-diameter protruding portion 113 is provided so as to be adjacent to the hub bearing 12 accommodated in the accommodation hole portion 111. More specifically, the small-diameter protruding portion 113 is provided so as to be adjacent to an end portion of the hub bearing 12 on the vehicle inner side. More specifically, the small-diameter protruding portion 113 is provided so as to be adjacent to the hub bearing 12 on the vehicle inner side of the stick sensor 13 that is fixed to the fixing portion 112. The small-diameter protruding portion 113 is provided annularly along the inner circumferential surface 111A.

The hub bearing 12 includes an outer ring 121, an inner ring 122, rolling balls 123, and a hub shaft 124. Here, the inner ring 122 and the hub shaft 124 constitute a “rotary body”. In the present embodiment, the hub bearing 12 includes the rolling balls 123. However, the hub bearing 12 may include rolling rollers, for instance, instead of the rolling balls 123.

The outer ring 121 is fixed to the hub carrier 11 by bolts or the like (not illustrated). The inner ring 122 cooperates with an inner circumferential surface of the outer ring 121 to roll the rolling balls 123 located on one side. The hub shaft 124 is connected to the inner ring 122 and cooperates with the inner circumferential surface of the outer ring 121 to roll the rolling balls 123 located on the other side.

At a distal end portion of the hub shaft 124 on the outer side in the left-right direction of the vehicle (i.e., on the outer side of the vehicle in the width direction of the vehicle), a wheel W1 that constitutes a wheel W is fastened by bolts and nuts (not illustrated) with a brake disc B sandwiched therebetween. Thus, the hub bearing 12 rotatably supports the wheel W (the wheel W1) via the inner ring 122 and the hub shaft 124, which constitute the rotary body.

As illustrated in FIG. 1, the drive shaft 20 is coupled to the vehicle wheel support device 10 in a case where the vehicle wheel support device 10 supports the driving wheel. In this case, the drive shaft 20 is coupled at one end thereof to the drive source M and at the other end thereof to the hub shaft 124 that constitutes the rotary body of the hub bearing 12.

In this case, the hub bearing 12 constitutes the driving wheel. The present embodiment exemplifies a case in which the drive shaft 20 is coupled to the hub shaft 124. Since the inner ring 122 and the hub shaft 124 are coupled to each other, however, the drive shaft 20 may be coupled to the inner ring 122, for instance.

The hub shaft 124 on the driving wheel side has, at a central portion thereof, a spline hole 125 in which the drive shaft 20 is disposed for enabling the driving force to be transmitted from the drive source M. In this configuration, the hub shaft 124 and the drive shaft 20 are held in a spline engagement, so that the hub shaft 124 on the driving wheel side transmits the drive force from the drive source M to the wheel W1, namely, the wheel W.

Further, the hub bearing 12 on the driving wheel side is provided with an annular seal 126 for isolating the inside of the hub bearing 12 from a space S into which foreign matter such as water, sand, and mud are allowed to enter. That is, the annular seal 126 prevents the foreign matter from entering between the outer ring 121 and the inner ring 122, so that the foreign matter does not hinder the rolling of the rolling balls 123. Thus, the inner structure of the hub bearing 12 on the driving wheel side is protected by the annular seal 126.

The present embodiment exemplifies, as the space S, a space in a tire housing in which the wheel W of the vehicle is housed, which space is located on the vehicle inner side (i.e., the inner side of the vehicle in the vehicle width direction) of the wheel W1, i.e., the wheel W. Specifically, the space S is exemplified as a space in the tire housing located on the vehicle inner side of one end portion of the hub bearing 12 that is accommodated in the accommodation hole portion 111 of the hub carrier 11. The foreign matter present on the road surface is allowed to enter the space S by being raised up due to rotation of the wheel W during traveling of the vehicle.

On the other hand, as illustrated in FIG. 2, the vehicle wheel support device 10 does not include the drive shaft 20 in a case where the vehicle support device 10 supports a wheel that is not driven by the drive source M, namely, in a case where the vehicle support device 10 supports the driven wheel. In this case, the hub bearing 12 is not coupled to the drive shaft 20. Accordingly, the hub shaft 124 on the driven wheel side is formed so as to be solid without including the spline hole 125.

A cap 14, which will be described later, is liquid-tightly attached to the hub bearing 12 provided on the driven wheel side so as to isolate the inside of the hub bearing 12 from the space S into which the foreign matter is allowed to enter. That is, the cap 14 prevents the foreign matter from entering between the outer ring 121 and the inner ring 122, so that the foreign matter does not hinder the rolling of the rolling balls 123. Thus, the inner structure of the hub bearing 12 on the driven wheel side is protected by the cap 14.

As illustrated in FIGS. 1 and 2, the hub bearing 12 is provided with a magnetized pulsar ring 127. The magnetized pulsar ring 127 is a multipolar magnet in which N poles and S poles are radially and alternately magnetized on an annular base. The magnetized pulsar ring 127 is disposed on the vehicle inner side of the hub bearing 12. More specifically, the magnetized pulsar ring 127 is disposed toward the inside of the accommodation hole portion 111 of the hub carrier 11.

More specifically, on the driving wheel side, the magnetized pulsar ring 127 is disposed on the vehicle inner side of the annular seal 126, as illustrated in FIG. 1. Thus, on the driving wheel side, the magnetized pulsar ring 127 directly faces the detection portion 131 of the stick sensor 13. On the driven wheel side, the magnetized pulsar ring 127 is disposed on the vehicle outer side of the cap 14 attached to the hub bearing 12, namely, on the inner side of the cap 14, as illustrated in FIG. 2. Thus, on the driven wheel side, the magnetized pulsar ring 127 faces the detection portion 131 of the stick sensor 13 via the cap 14.

The sensor 13 detects a rotation state of the inner ring 122 or the hub shaft 124 constituting the rotary body of the hub bearing 12. As illustrated in FIGS. 1 and 2, the sensor 13 of the present embodiment detects the rotation state of the inner ring 122 constituting the rotary body of the hub bearing 12 about the axis of the inner ring 122, in other words, the rotation state of the wheel W. As the sensor 13, a wheel speed sensor that detects a wheel speed is exemplified. In the following description, the sensor 13 is a wheel speed sensor. The sensor 13 may be a sensor that detects another physical quantity.

As illustrated in FIGS. 1 and 2, the stick sensor 13 includes, at its distal end portion, the detection portion 131 that detects the rotation state. The detection portion 131 protrudes from the inner circumferential surface 111A of the accommodation hole portion 111 in a state in which the stick sensor 13 is fixed to the fixing portion 112 of the hub carrier 11. The detection portion 131 faces the magnetized pulsar ring 127 provided on the hub bearing 12 with an air gap, which is a predetermined gap, interposed therebetween. Thus, the stick sensor 13 detects a change in the magnetic flux density and converts the detected change in the magnetic flux density to the rotational speed of the wheel W, namely, the wheel speed.

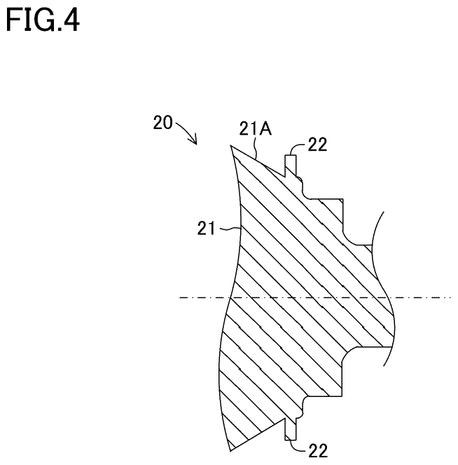

As illustrated in FIG. 4, the drive shaft 20 has a large-diameter protruding portion 22 provided on an outer circumferential surface 21A of a shaft body 21. The large-diameter protruding portion 22 cooperates with the small-diameter protruding portion 113 of the hub carrier 11 to prevent the foreign matter from entering from the space S toward the detection portion 131. Thus, the large-diameter protruding portion 22 is provided annularly along the outer circumferential surface 21A of the shaft body 21.

In the present embodiment, as illustrated in FIG. 1, the large-diameter protruding portion 22 is disposed so as to be adjacent to the small-diameter protruding portion 113 in an entering direction D of the foreign matter entering toward the detection portion 131. More specifically, the large-diameter protruding portion 22 is disposed on the upstream side (the vehicle inner side) of the small-diameter protruding portion 113 in the entering direction D, that is, the large-diameter protruding portion 22 is disposed on one of opposite sides of the small-diameter protruding portion 113 in the entering direction D that is nearer to the space S.

In the present embodiment, an outer diameter of the large-diameter protruding portion 22 is greater than an inner diameter of the small-diameter protruding portion 113. Accordingly, the large-diameter protruding portion 22 and the small-diameter protruding portion 113 are disposed so as to be adjacent to each other and overlap each other in a direction orthogonal to the axis, in other words, overlap each other as viewed in the axial direction. Thus, the large-diameter protruding portion 22 and the small-diameter protruding portion 113 can exhibit a labyrinth effect. On the driving wheel side, in particular, the large-diameter protruding portion 22 can move relative to the small-diameter protruding portion 113 as the drive shaft 20 rotates. As a result, on the driving wheel side, it is possible to more effectively prevent the foreign matter from entering from a gap between the large-diameter protruding portion 22 and the small-diameter protruding portion 113 at the overlapping portion.

The cap 14 is formed in a disk shape and is attached to the hub bearing 12 on the driven wheel side. As illustrated in FIG. 2, the cap 14 prevents the foreign matter from entering the hub bearing 12 from a space S on the driven wheel side. The cap 14 is disposed in the space S on the driven wheel side so as to isolate, from the foreign matter, the detection portion 131 of the stick sensor 13 fixed to the hub carrier 11.

In the present embodiment, the cap 14 is formed by molding of a resin material. Specifically, in the present embodiment, the cap 14 is formed by injection molding in which a resin material is injected into a mold. Examples of the resin material for forming the cap 14 include polypropylene (PP), polyethylene (PE), polyamide (PA), polyvinyl chloride (PVC), and ABS resin (copolymer synthetic resin of acrylonitrile (A), butadiene (B), and styrene(S)). The cap 14 may be integrally formed by a press work of a thin steel plate using a forming die. The cap 14 may be formed by welding of members formed by a press work.

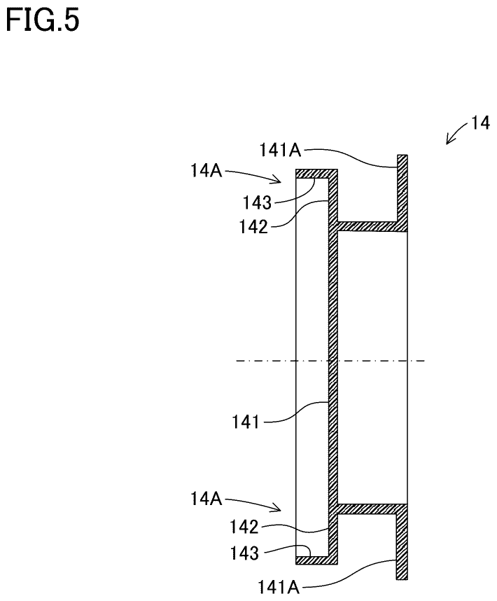

As illustrated in FIG. 5, the cap 14 has a hat-shaped cap body 141, a large-diameter protruding portion 142, and a repelling portion 143. The present embodiment exemplifies a case in which the large-diameter protruding portion 142 and the repelling portion 143 are formed integrally with the cap body 141. In the following description, the large-diameter protruding portion 142 and the repelling portion 143 constitute a “deflector member 14A”.

The cap body 141 has a flange portion 141A. The cap body 141, namely, the cap 14, is attached to the hub bearing 12 by fixing the flange portion 141A to the inner circumferential surface of the outer ring 121 of the hub bearing 12. Thus, the cap body 141 prevents the foreign matter from entering the inside of the hub bearing 12 from the space S on the driven wheel side. In fixing the flange portion 141A to the outer ring 121 of the hub bearing 12, the flange portion 141A may be fitted in a groove (not illustrated) formed in the inner circumferential surface of the outer ring 121 along the circumferential direction, so as to be fixed to the outer ring 121.

The large-diameter protruding portion 142 is formed so as to extend radially outward from the cap body 141 along the outer circumferential surface of the cap body 141. Accordingly, in a state in which the cap body 141 is attached to the hub bearing 12, the large-diameter protruding portion 142 covers the side surface of the detection portion 131 of the stick sensor 13 so as to isolate the detection portion 131 in the space S on the driven wheel side. With this configuration, the large-diameter protruding portion 142 prevents the foreign matter scattered toward the detection portion 131 of the stick sensor 13 in the space S on the driven wheel side from adhering to the detection portion 131.

In a state in which the cap 14 is attached to the hub bearing 12, the large-diameter protruding portion 142 is disposed so as to be adjacent to the small-diameter protruding portion 113 in the entering direction D of the foreign matter, as illustrated in FIG. 2. More specifically, the large-diameter protruding portion 142 is disposed on the upstream side (the vehicle inner side) of the small-diameter protruding portion 113 in the entering direction D, namely, the large-diameter protruding portion 142 is disposed on one of opposite sides of the small-diameter protruding portion 113 in the entering direction D that is nearer to the space S.

The large-diameter protruding portion 142 has an outer diameter greater than an inner diameter of the small-diameter protruding portion 113. Thus, when the cap 14 is attached to the hub bearing 12, the large-diameter protruding portion 142 and the small-diameter protruding portion 113 are disposed so as to be adjacent to each other and overlap each other in a direction orthogonal to the axis of the cap 14, in other words, overlap each other as viewed in the axial direction. Therefore, also in the cap 14, the large-diameter protruding portion 142 and the small-diameter protruding portion 113 exhibit the labyrinth effect. As a result, also on the driven wheel side, it is possible to prevent the foreign matter from entering from the gap between the large-diameter protruding portion 142 and the small-diameter protruding portion 113 at the overlapping portion, by attaching the cap 14 to the hub bearing 12.

The repelling portion 143 of the cap 14 extends axially toward the vehicle inner side from an outer circumferential edge of the large-diameter protruding portion 142 located at a radially outward portion of the large-diameter protruding portion 142 (FIG. 2). That is, the repelling portion 143 is formed so as to be coaxial with the cap body 141. With this configuration, the repelling portion 143 repels the foreign matter that enters from the space S on the driven wheel side toward the detection portion 131 of the stick sensor 13. On the driven wheel side, therefore, it is possible to not only prevent entry of the foreign matter owing to the labyrinth effect but also prevent the foreign matter from adhering to the detection portion 131 by the repelling portion 143 configured to repel the foreign matter.

In the present embodiment, the deflector member 14A includes the repelling portion 143. However, the repelling portion 143 may be omitted as necessary. In this case, the deflector member 14A is constituted only by the large-diameter protruding portion 142.

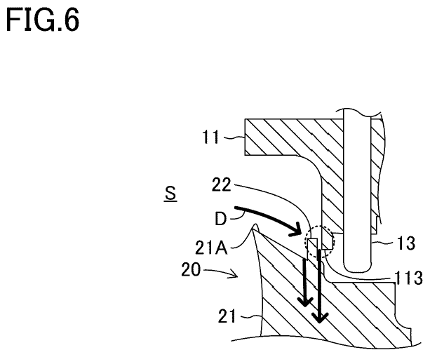

In the vehicle wheel support device 10 configured as described above, the hub carrier 11 includes the small-diameter protruding portion 113. On the driving wheel side, the large-diameter protruding portion 22 of the drive shaft 20 is provided so as to be adjacent to the small-diameter protruding portion 113 on one of the opposite sides thereof in the entering direction D that is nearer to the space S. With this configuration, the large-diameter protruding portion 22 and the small-diameter protruding portion 113 cooperate with each other to prevent entry of the foreign matter scattered toward the detection portion 131 of the stick sensor 13 in the space S on the driving wheel side, as indicated by thick arrows and a dashed circle in FIG. 6.

That is, on the driving wheel side, the large-diameter protruding portion 22 and the small-diameter protruding portion 113 exhibit the labyrinth effect so as to inhibit entry of the foreign matter and prevent the foreign matter from reaching the detection portion 131. In other words, the large-diameter protruding portion 22 closes or blocks a hole formed by the small-diameter protruding portion 113, namely, a hole communicating with the accommodation hole portion 111, thereby inhibiting entry of the foreign matter and preventing the foreign matter from reaching the detection portion 131. As a result, on the driving wheel side, the foreign matter is unlikely to be present in the detection portion 131 of the stick sensor 13, particularly in the air gap between the detection portion 131 and the magnetized pulsar ring 127. It is thus possible to prevent the detection accuracy of the stick sensor 13 from being deteriorated.

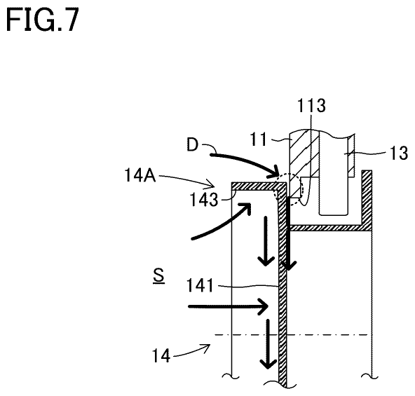

On the other hand, in the vehicle wheel support device 10 on the driven wheel side, the cap 14 is attached to the hub bearing 12. In the cap 14, as indicated by thick arrows in FIG. 7, the cap body 141 prevents entry of the foreign matter from the space S on the driven wheel side, and the deflector member 14A prevents entry of the foreign matter scattered toward the detection portion 131 of the stick sensor 13 in the space S on the driven wheel side.

Also in the vehicle wheel support device 10 on the driven wheel side, the hub carrier 11 includes the small-diameter protruding portion 113. On the driven wheel side, the large-diameter protruding portion 142 of the cap 14 is provided so as to be adjacent to the small-diameter protruding portion 113 on one of its opposite sides in the entering direction D that is nearer to the space S. With this configuration, the large-diameter protruding portion 142 and the small-diameter protruding portion 113 cooperate with each other to prevent entry of the foreign matter scattered toward the detection portion 131 of the stick sensor 13 in the space S on the driven wheel side, as indicated by thick arrows and a dashed circle in FIG. 7.

That is, on the driven wheel side, the large-diameter protruding portion 142 and the repelling portion 143 formed integrally with the cap 14, i.e., the deflector member 14A, inhibits entry of the foreign matter and prevents the foreign matter from reaching the detection portion 131. On the driven wheel side, the large-diameter protruding portion 142 and the small-diameter protruding portion 113 exhibit the labyrinth effect so as to inhibit entry of the foreign matter and prevent the foreign matter from reaching the detection portion 131. On the driven wheel side, therefore, the foreign matter is unlikely to be present in the air gap between the detection portion 131 and the magnetized pulsar ring 127 via the flange portion 141A of the cap 14. It is thus possible to prevent the detection accuracy of the stick sensor 13 from being deteriorated.

As can be understood from the above description, the vehicle wheel support device 10 includes the hub bearing 12 that rotatably supports the wheel W (the wheel W1), the hub carrier 11 that supports the hub bearing 12, the sensor 13 that detects the rotation state of the wheel W, and the drive shaft 20 or the cap 14, as an assembly member, that is assembled to at least one of the hub bearing 12 and the hub carrier 11. In the vehicle wheel support device 10, the drive shaft 20 includes the large-diameter protruding portion 22 that cooperates with the hub carrier 11 to prevent entry of the foreign matter toward the sensor 13, and the cap 14 includes the large-diameter protruding portion 142 that cooperates with the hub carrier 11 to prevent entry of the foreign matter toward the sensor 13.

In this case, the hub carrier 11 includes the accommodation hole portion 111 in which part of the hub bearing 12 is accommodated and the small-diameter protruding portion 113 provided along the inner circumferential surface 111A of the accommodation hole portion 111 so as to prevent entry of the foreign matter in cooperation with the large-diameter protruding portion 22.

In this case, the sensor 13 is fixed to the fixing portion 112 of the hub carrier 11 in a state in which the detection portion 131 configured to detect the rotation state of the hub shaft 124 (including the connected inner ring 122) about its axis, which is the rotary body of the hub bearing 12 connected to the wheel W (the wheel W1), protrudes from the inner circumferential surface 111A, and the small-diameter protruding portion 113 is disposed between the large-diameter protruding portion 22 and the detection portion 131 in the entering direction D of the foreign matter toward the detection portion 131.

In this case, the large-diameter protruding portion 22 is disposed so as to be adjacent to the small-diameter protruding portion 113 in the entering direction D of the foreign matter toward the sensor 13 (the detection portion 131).

In this case, the outer diameters of the large-diameter protruding portion 22 and the large-diameter protruding portion 142 are greater than the inner diameter of the small-diameter protruding portion 113.

In this case, the drive shaft 20 is coupled to the hub bearing 12 so as to transmit the driving force from the drive source M, and the large-diameter protruding portion 22 is provided along the outer circumferential surface 21A of the shaft body 21 of the drive shaft 20.

In this case, the cap 14 is attached to the hub bearing 12 so as to prevent entry of the foreign matter into the hub bearing 12, and the large-diameter protruding portion 142 is provided along the outer circumferential surface of the cap body 141 of the cap 14.

In this case, the large-diameter protruding portion 142 is formed integrally with the cap body 141 of the cap 14.

In these cases, the large-diameter protruding portion 142 includes the repelling portion 143 that is formed at the outer circumferential portion thereof and that is configured to repel the foreign matter entering toward the detection portion 131.

According to the vehicle wheel support device 10, the small-diameter protruding portion 113 of the hub carrier 11 and the large-diameter protruding portion 22 of the drive shaft 20 cooperate with each other to exhibit the labyrinth effect, thus preventing the foreign matter from adhering to the sensor 13. Moreover, the large-diameter protruding portion 22 closes or blocks the hole (the hole communicating with the accommodation hole portion 111) formed by the small-diameter protruding portion 113, thus inhibiting entry of the foreign matter and preventing the foreign matter from reaching the detection portion 131. In the driving wheel of the vehicle, therefore, it is not necessary to separately prepare and assemble a deflector that will be described later, and the number of components can be reduced. The reduction in the number of components, namely, the omission of the deflector, eliminates the need for performing an assembly work. As a result, the cost can be reduced.

In the vehicle wheel support device 10 in the driven wheel that is not provided with the drive shaft 20, the large-diameter protruding portion 142 and the repelling portion 143 formed integrally with the cap body 141 of the cap 14 isolate the detection portion 131 of the sensor 13 in the space S into which the foreign matter is allowed to enter. Further, also on the driven wheel side, the small-diameter protruding portion 113 and the large-diameter protruding portion 142 cooperate with each other to exhibit the labyrinth effect and close or block the hole formed by the small-diameter protruding portion 113, thus preventing the foreign matter from adhering to the sensor 13.

In the vehicle wheel support device 10 on the driven wheel side, even if the deflector is omitted, the small-diameter protruding portion 113 and the large-diameter protruding portion 22 cooperate with each other to prevent the foreign matter from adhering to the sensor 13. In the vehicle wheel support device 10 on the driven wheel side, the cap 14 attached to the hub bearing 12 prevents the foreign matter from adhering to the sensor 13 by cooperation of the small-diameter protruding portion 113 and the large-diameter protruding portion 142. Thus, the vehicle wheel support device 10 enables the sensor 13 to be fixed to the hub carrier 11 both in the driving wheel and the driven wheel. According to the vehicle wheel support device 10, the common hub carrier 11 can be employed in the driving wheel and the driven wheel, and the sensor 13, the wire harness, and the connector can be used in common between the driving wheel and the driven wheel. There will be next described modifications of the embodiment illustrated above.

Hereinafter, a first modification to a fourth modification will be described in order.

### First Modification

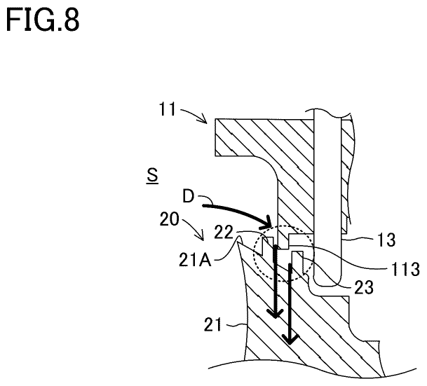

In the embodiment illustrated above, the drive shaft 20 includes one large-diameter protruding portion 22. In the first modification, as indicated by a dashed circle in FIG. 8, two large-diameter protruding portions 22, 23 are provided along the entering direction D. That is, the drive shaft 20 of the first modification includes the two large-diameter protruding portions 22 and 23 provided on the outer circumferential surface 21A of the shaft body 21. Specifically, in the first modification, the large-diameter protruding portion 23 is provided on the other of the opposite sides (i.e., the vehicle outer side) of the small-diameter protruding portion 113 in the entering direction D, that is, the large-diameter protruding portion 23 is provided between the small-diameter protruding portion 113 and the stick sensor 13.

In the first modification, therefore, even if the foreign matter enters through the gap between the large-diameter protruding portion 22 and the small-diameter protruding portion 113, the large-diameter protruding portion 23 prevents entry of the foreign matter toward the stick sensor 13. Other effects are similar to those of the illustrated embodiment.

In the first modification, the large-diameter protruding portion 23 has an outer diameter smaller than the inner diameter of the small-diameter protruding portion 113. With this configuration, the work of coupling the drive shaft 20 and the hub shaft 124 can be performed without interference between the large-diameter protruding portion 23 and the small-diameter protruding portion 113.

### Second Modification

In the illustrated embodiment, the large-diameter protruding portion 22 and the small-diameter protruding portion 113 are disposed so as to be adjacent to each other in the entering direction D, and the outer diameter of the large-diameter protruding portion 22 is greater than the inner diameter of the small-diameter protruding portion 113. In this configuration of the illustrated embodiment, the portion where the large-diameter protruding portion 22 and the small-diameter protruding portion 113 overlap each other is generated, so that the labyrinth effect is exhibited.

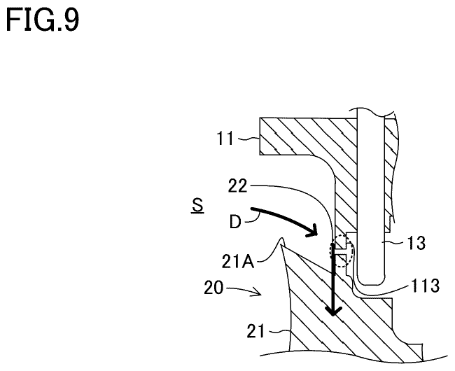

In the second modification, the outer diameter of the large-diameter protruding portion 22 is smaller than the inner diameter of the small-diameter protruding portion 113, and the large-diameter protruding portion 22 and the small-diameter protruding portion 113 are disposed so as to face each other, as illustrated in FIG. 9. With this configuration, as indicated by a dashed circle in FIG. 9, the large-diameter protruding portion 22 and the small-diameter protruding portion 113 cooperate with each other to isolate the detection portion 131 of the stick sensor 13 from the space S.

Also in the second modification, the large-diameter protruding portion 22 can move relative to the small-diameter protruding portion 113 in accordance with the rotation of the drive shaft 20. In the second modification, even if the foreign matter enters the gap between the large-diameter protruding portion 22 and the small-diameter protruding portion 113, it is possible to prevent entry of the foreign matter toward the detection portion 131 by the rotation of the large-diameter protruding portion 22. Therefore, the second modification also offers effects similar to those of the illustrated embodiment.

### Third Modification

In the illustrated embodiment, the cap 14 on the driven wheel side is made of resin, and the cap 14 is integrally formed so as to have the large-diameter protruding portion 142 and the repelling portion 143. However, a deflector 15 made of metal, which has been conventionally used on the driving wheel side, may be used on the driven wheel side.

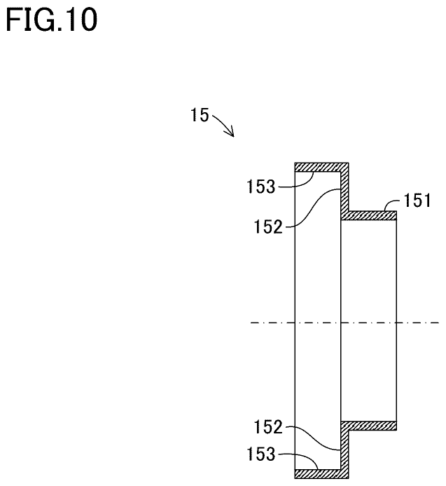

The deflector 15 made of metal is formed by a press work of a thin steel plate, for instance. As illustrated in FIG. 10, the deflector 15 includes a cylindrical portion 151, and a disk portion 152 and a repelling portion 153 respectively corresponding to the large-diameter protruding portion 142 and the repelling portion 143 that constitute the deflector member 14A of the cap 14 described above. In the third modification, the cap 14 may be made of resin as in the illustrated embodiment or may be formed by a press work of a thin steel plate, for instance.

The cylindrical portion 151 has an inner diameter slightly smaller than the outer diameter of the cap body 141 of the cap 14. That is, the inner diameter of the cylindrical portion 151 has a dimension with an interference such that the cylindrical portion 151 is fitted to the cap body 141. In the deflector 15, the cylindrical portion 151 is fitted to the cap body 141, e.g., press-fitted to the cap body 141, so that the deflector 15 is fixed to the cap body 141.

The disk portion 152 is connected to the cylindrical portion 151 so as to extend therefrom in the radially outward direction. Thus, in a state in which the cylindrical portion 151 is fixed to the cap body 141, the disk portion 152 covers the side surface of the detection portion 131 of the stick sensor 13 so as to isolate the detection portion 131 in the space S on the driven wheel side. With this configuration, like the large-diameter protruding portion 142 of the deflector member 14A in the illustrated embodiment, the disk portion 152 cooperates with the small-diameter protruding portion 113 to prevent the foreign matter scattered toward the detection portion 131 of the stick sensor 13 in the space S on the driven wheel side from adhering to the detection portion 131.

The repelling portion 153 is provided along the outer circumferential edge of the disk portion 152. The repelling portion 153 is connected to the disk portion 152 so as to axially extend therefrom, namely, so as to be coaxial with the cylindrical portion 151. With this configuration, the repelling portion 153 repels the foreign matter that enters from the space S on the driven wheel side toward the detection portion 131 of the stick sensor 13.

In the third modification, the deflector 15 includes the repelling portion 153. However, the repelling portion 153 may be omitted as necessary. In this case, the deflector 15 is constituted by the cylindrical portion 151 and the disk portion 152.

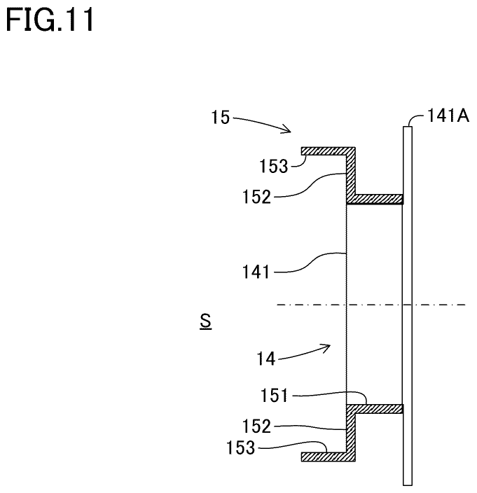

In the third modification, the deflector 15 is fitted, at the cylindrical portion 151, to the cap body 141 that is a predetermined position, as illustrated FIG. 11. For instance, the deflector 15 is fixed integrally to the cap 14 such that the cylindrical portion 151 is press-fitted to the cap body 141. This configuration in which the cap 14 is thus formed also offers effects similar to those in the illustrated embodiment.

### Fourth Modification

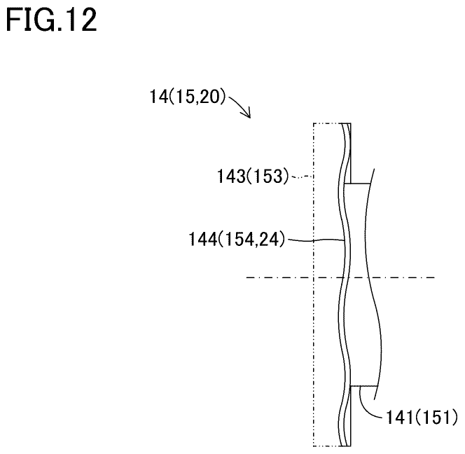

As illustrated in FIG. 12, the drive shaft 20. the cap 14, and the deflector 15 are partially changed in a fourth modification. In the fourth modification, the drive shaft 20, the cap 14, and the deflector 15 respectively includes a large-diameter protruding portion 24, a large-diameter protruding portion 144, and a disk portion 154 instead of the flat plate-shaped large-diameter protruding portion 22, the flat plate-shaped large-diameter protruding portion 142, and the flat plate-shaped disk portion 152, respectively, in the illustrated embodiment and the third modification. The large-diameter protruding portion 24, the large-diameter protruding portion 144, and the disk portion 154 have a plurality of concavities and convexities formed along the circumferential direction. The large-diameter protruding portion 24, the large-diameter protruding portion 144, and the disk portion 154 each having a plurality of concavities and convexities can suppress adhesion of the foreign matter. It is thus possible to prevent entry of the foreign matter toward the detection portion 131 of the stick sensor 13 from the space S on the driven wheel side. The other effects are similar to those of the illustrated embodiment.

### Other Modifications

In the illustrated embodiment and the modifications described above, the hub carrier 11 includes the small-diameter protruding portion 113 formed along the inner circumferential surface 111A of the accommodation hole portion 111, and the small-diameter protruding portion 113 cooperates with the large-diameter protruding portion 22 of the drive shaft 20 or the large-diameter protruding portion 142 of the cap 14. However, the small-diameter protruding portion 113 of the hub carrier 11 may be omitted.

In this case, the large-diameter protruding portion 22 or the large-diameter protruding portion 142 can cooperate with a side surface of the hub carrier 11 (a surface facing the large-diameter protruding portion 22 or the large-diameter protruding portion 142) to prevent entry of the foreign matter. With this configuration, even if the hub carrier 11 does not include the small-diameter protruding portion 113, the large-diameter protruding portion 22 or the large-diameter protruding portion 142 closes the accommodation hole portion 111 on the vehicle inner side, so as to prevent the foreign matter from adhering to the sensor 13.

The illustrated embodiment and the modifications described above exemplify, as the assembly member, the drive shaft 20 coupled to the hub bearing 12 on the driving wheel side and the cap 14 attached to the hub bearing 12 on the driven wheel side. The assembly member is not limited to the drive shaft 20 and the cap 14 but may be, for example, a housing of a motor or a housing of a speed reduction mechanism connected to the hub bearing 12, a cap attached to the hub carrier 11, or a cap attached to both the hub carrier 11 and the hub bearing 12.

Here, a vehicle wheel support device according to a first aspect of the present disclosure includes: a hub bearing that rotatably supports a wheel; a hub carrier that supports the hub bearing; a sensor that detects a rotation state of the wheel; and an assembly member that is assembled to the hub bearing, the hub carrier, or both the hub bearing and the hub carrier, and the assembly member has a large-diameter protruding portion that cooperates with the hub carrier to prevent entry of foreign matter toward the sensor.

A vehicle wheel support device according to a second aspect of the present disclosure is formed as follows. In the vehicle wheel support device according to the first aspect, the hub carrier includes an accommodation hole portion in which part of the hub bearing is accommodated and a small-diameter protruding portion provided along an inner circumferential surface of the accommodation hole portion so as to prevent entry of the foreign matter in cooperation with the large-diameter protruding portion.

A vehicle wheel support device according to a third aspect of the present disclosure is formed as follows. In the vehicle wheel support device according to the second aspect, the large-diameter protruding portion is disposed so as to be adjacent to the small-diameter protruding portion in an entering direction of the foreign matter toward the sensor.

A vehicle wheel support device according to a fourth aspect of the present disclosure is formed as follows. In the vehicle wheel support device according to the third aspect, a plurality of large-diameter protruding portions, each as the large-diameter protruding portion, are arranged along the entering direction.

A vehicle wheel support device according to a fifth aspect of the present disclosure is formed as follows. In the vehicle wheel support device according to any one of the second aspect to the fourth aspect, an outer diameter of the large-diameter protruding portion is greater than an inner diameter of the accommodation hole portion or an inner diameter of the small-diameter protruding portion.

A vehicle wheel support device according to a sixth aspect of the present disclosure is formed as follows. In the vehicle wheel support device according to the second aspect, an outer diameter of the large-diameter protruding portion is smaller than an inner diameter of the small-diameter protruding portion, and the large-diameter protruding portion and the small-diameter protruding portion are disposed so as to face each other.

A vehicle wheel support device according to a seventh aspect of the present disclosure is formed as follows. In the vehicle wheel support device according to any one of the second aspect to the sixth aspect, the sensor is fixed to a fixing portion of the hub carrier in a state in which a detection portion of the sensor protrudes from the inner circumferential surface of the accommodation hole portion, the detection portion being configured to detect a rotation state of a rotary body of the hub bearing about an axis of the rotary body, the rotary body being connected to the wheel, and the small-diameter protruding portion is disposed between the large-diameter protruding portion and the detection portion in an entering direction of the foreign matter toward the detection portion.

A vehicle wheel support device according to an eighth aspect of the present disclosure is formed as follows. In the vehicle wheel support device according to any one of the second aspect to the seventh aspect, the assembly member is a drive shaft coupled to the hub bearing so as to transmit a driving force from a drive source, and the drive shaft includes the large-diameter protruding portion.

A vehicle wheel support device according to a ninth aspect of the present disclosure is formed as follows. In the vehicle wheel support device according to any one of the second aspect to the eighth aspect, the assembly member is a cap attached to the hub bearing so as to prevent entry of the foreign matter into the hub bearing, and the cap includes the large-diameter protruding portion.

A vehicle wheel support device according to a tenth aspect of the present disclosure is formed as follows. In the vehicle wheel support device according to the ninth aspect, the large-diameter protruding portion is formed integrally with the cap.

A vehicle wheel support device according to an eleventh aspect of the present disclosure is formed as follows. In the vehicle wheel support device according to any one of the first aspect to the tenth aspect, the large-diameter protruding portion includes a plurality of concavities and convexities formed along a circumferential direction thereof.

A vehicle wheel support device according to a twelfth aspect of the present disclosure is formed as follows. In the vehicle wheel support device according to any one of the first aspect to the eleventh aspect, the large-diameter protruding portion includes a repelling portion formed at an outer circumferential portion thereof, the repelling portion being configured to repel the entering foreign matter.

What is claimed is:

1. A vehicle wheel support device, comprising:
a hub bearing that rotatably supports a wheel;
a hub carrier that supports the hub bearing;
a sensor that detects a rotation state of the wheel; and
an assembly member that is assembled to the hub bearing, the hub carrier, or both the hub bearing and the hub carrier,
wherein the assembly member has a large-diameter protruding portion that cooperates with the hub carrier to prevent entry of foreign matter toward the sensor.

2. The vehicle wheel support device according to claim 1, wherein the hub carrier includes an accommodation hole portion in which part of the hub bearing is accommodated and a small-diameter protruding portion provided along an inner circumferential surface of the accommodation hole portion so as to prevent entry of the foreign matter in cooperation with the large-diameter protruding portion.

3. The vehicle wheel support device according to claim 2, wherein the large-diameter protruding portion is disposed so as to be adjacent to the small-diameter protruding portion in an entering direction of the foreign matter toward the sensor.

4. The vehicle wheel support device according to claim 3, wherein a plurality of large-diameter protruding portions, each as the large-diameter protruding portion, are arranged along the entering direction.

5. The vehicle wheel support device according to claim 2, wherein an outer diameter of the large-diameter protruding portion is greater than an inner diameter of the accommodation hole portion or an inner diameter of the small-diameter protruding portion.

6. The vehicle wheel support device according to claim 2,
wherein an outer diameter of the large-diameter protruding portion is smaller than an inner diameter of the small-diameter protruding portion, and
wherein the large-diameter protruding portion and the small-diameter protruding portion are disposed so as to face each other in an axial direction of the hub bearing.

7. The vehicle wheel support device according to claim 2,
wherein the sensor is fixed to a fixing portion of the hub carrier in a state in which a detection portion of the sensor protrudes from the inner circumferential surface of the accommodation hole portion, the detection portion being configured to detect a rotation state of a rotary body of the hub bearing about an axis of the rotary body, the rotary body being connected to the wheel, and
wherein the small-diameter protruding portion is disposed between the large-diameter protruding portion and the detection portion in an entering direction of the foreign matter toward the detection portion.

8. The vehicle wheel support device according to claim 1,
wherein the assembly member is a drive shaft coupled to the hub bearing so as to transmit a driving force from a drive source, and
wherein the drive shaft includes the large-diameter protruding portion.

9. The vehicle wheel support device according to claim 1,
wherein the assembly member is a cap attached to the hub bearing so as to prevent entry of the foreign matter into the hub bearing, and
wherein the cap includes the large-diameter protruding portion.

10. The vehicle wheel support device according to claim 9, wherein the large-diameter protruding portion is formed integrally with the cap.

11. The vehicle wheel support device according to claim 1, wherein the large-diameter protruding portion includes a plurality of concavities and convexities formed along a circumferential direction thereof.

12. The vehicle wheel support device according to claim 1, wherein the large-diameter protruding portion includes a repelling portion formed at an outer circumferential portion thereof, the repelling portion being configured to repel the entering foreign matter.
